(19) United States
(12) Patent Application Publication
(10) Pub. No.: US 2012/0034544 A1
(43) Pub. Date: Feb. 9, 2012

(54) FUEL CELL ARRANGEMENT

(76) Inventor: Timo Mahlanen, Helsinki (FI)

(21) Appl. No.: 13/119,561

(22) PCT Filed: Oct. 15, 2009
(86) PCT No.: PCT/FI2009/050831

§ 371 Date: Mar. 17, 2011

(30) Foreign Application Priority Data
Oct. 17, 2008 (FI) 20085977

(51) Int. Cl. H01M 8/04; H01M 2/10; H01M 8/24

(52) U.S. Cl. 429/458

(57) ABSTRACT

A fuel cell arrangement (1) comprising a number of fuel cell stacks (2) formed by planar fuel cells, the stacks being arranged one after the other, each of which being provided with a gas connection for the inlet and exhaust flows of the gas of the anode and the cathode side. The fuel cell stacks (2) are arranged together positioned over a fastening plane element (3) by means of an end piece (5) and the fastening plane element (3) and tie bars (6) connecting them. The gas connection comprises anode and cathode side conduits arranged on the first surface (2.1) of each fuel cell stack. The arrangement comprises at least two consecutive fuel cell stacks (2) the anode and cathode side conduits of which are in connection with a common inlet and collector piece (4.1, 4.2) located between the said two consecutive fuel cell stacks (2) against the said first surfaces.

The present invention relates to a fuel cell arrangement according to the preamble of claim 1 comprising a number of fuel cell stacks formed by planar fuel cells, the stacks being arranged, one after the other, each of which being provided with a gas connection for the inlet and outlet flows of the gas of the anode and the cathode side.

Electric energy can be produced by means of fuel cells by releasing electrons by oxidizing fuel gas on the anode side and to further combine the electrons on the cathode side by reducing oxygen or by using other reducing agent subsequent to the electrons having passed through an external circuit producing work. In order to produce the action each fuel cell must be provided with fuel and oxygen or other reducing agent. Usually this is effected by providing a flow of fuel and air to the anode and cathode sides. Typically, the potential difference produced by a single fuel cell is, however, so small that in practice a fuel cell unit, i.e. a stack, is produced from a number of fuel cells by connecting a number of cells electrically in series. Separate units can then be further connected in series for increasing the voltage. Each fuel cell unit, i.e. a fuel cell stack must be provided with the substances needed for the reaction, fuel and oxygen (air). The reaction products must correspondingly be transported away from the units. This necessitates a gas flow system for accomplishing gas flows for both the cathode and anode sides. In practice, in a fuel cell plant, fuel cell stacks must be connected in series for providing sufficient electric power and to further connect in parallel such assemblies connected in series. It is thus obvious that forming both the connections for electric flows and gas flows will be problematic.

U.S. Pat. No. 6,692,859B2 discloses one solution for realizing the gas flows of fuel cell stacks. This kind of solution produces a solution with a non-optimal space usage in case the arrangement is to be one of higher power.

The object of the invention is to produce a fuel cell arrangement that is easy to install and service and in which the design of the gas change system of the fuel cell stacks is as simple, durable and optimal in space usage as possible.

The object of the invention is achieved as described in claim 1 and as disclosed in more detail in other claims. The fuel cell arrangement according to the invention comprises fuel cell stacks formed by planar fuel cells connected together and arranged over a fastening plane element by means of an end piece and fastening plane element and tie bars connecting them. A further characterizing feature of the invention is that the gas flow connection comprises anode and cathode side conduits arranged on the first surface of the fuel cell stack and that the arrangement comprises at least two fuel cell stacks arranged one after the other, the conduits of the anode and cathode side being in connection with a common inlet and collector piece being arranged against the first surfaces of the said two consecutive fuel cell stacks. This allows an advantageous solution for the gas change and thermal expansion of the stacks.

The fuel cell stacks are arranged so that the terminals of the fuel cell stack having the same polarity are facing each other on both sides of the inlet and collector piece. This has the advantage that the electric insulation between the stacks is easy to arrange due to the minimal potential difference.

Preferably the arrangement comprises at least two pairs of two consecutive fuel cell stacks connected by means of an inlet and collector piece formed as a tower one after the other. This allows an efficient use of space. The inlet and collector pieces are connected to the common gas pipes of the anode and cathode side via which the gas transfer between the fuel cell stacks and the fastening plane is carried out. Preferably the gas pipes are provided with a bellows installed between each inlet and collector means for compensating thermal expansion.

The holes for the tie bars in inlet and collector pieces are provided with an insulation acting as an electric insulation between the connecting bar and the inlet and collector piece. This allows the tie bars and further the fastening substrate to be electrically insulated from the fuel cell stacks.

The arrangement preferably comprises a number of towers formed of fuel cell stacks, the stacks being attached to the same fastening plane element comprising the gas flow channels for the anode and cathode sides, the gas flow channels being connected to the ducts of the anode and cathode sides via inlet and collector pieces. The electric connection is made by connecting the fuel cell stacks corresponding to each other in the fastening level in series in different towers.

In the following, the invention is described in more detail with reference to the appended schematic drawings, in which

FIG. 1 illustrates one embodiment of a fuel cell arrangement according to the invention,

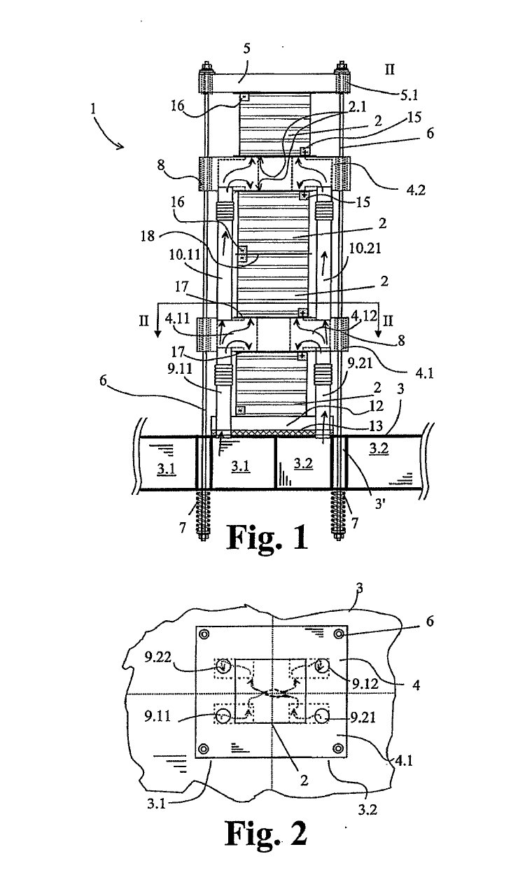

FIG. 2 illustrates the section II-II of FIG. 1,

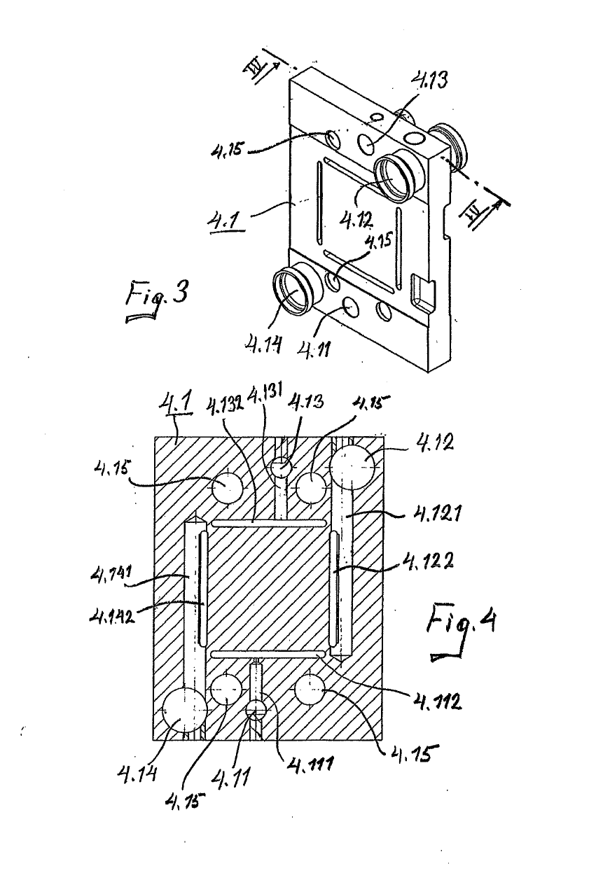

FIG. 3 illustrates an embodiment of an inlet and collector piece included in a fuel cell arrangement according to the invention.

FIG. 4 illustrates the section IV-IV of FIG. 3, and

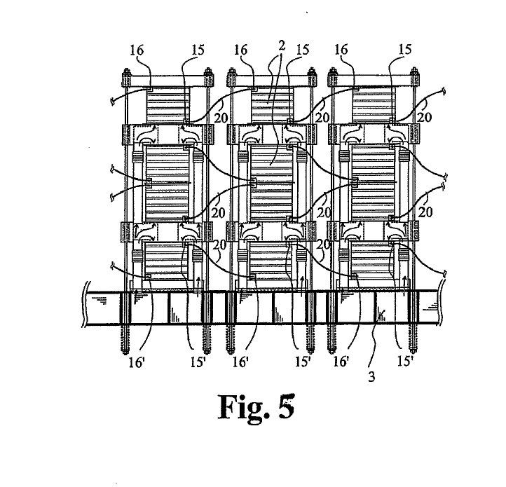

FIG. 5 illustrates the connection principle of a number of fuel cell arrangements.

FIGS. 1 and 2 illustrate the principle of a fuel cell arrangement 1 formed of so-called stacks 2 comprising planar fuel cells. The fuel cells 2 are arranged into fuel cell towers on a fastening plane element 3 so that the first end of the tower comprises a first end piece 5 pressing the stacks by means of tie bars 6. The tie bars extend from the fastening plane element 3 to the first end piece 5 and they are provided with a tightening arrangement 7 at least in the end facing the fastening plane element. The tightening arrangement is preferably produced by means of a spring, the tightening force of which is adjusted by means of a tightening nut provided in connection with the tie bar so as to be suitable. The tie bars 5 pass through the fastening plane to the other side thereof via an essentially gas-proof space 3′, such as a sleeve, whereby the spring as well as the tie bar are in a lower temperature than that on the side of the fuel cell stacks. Thus the conditions are better for the operation and durability of the spring than on the side of the fuel cell stacks in a higher temperature, typically over 500° C.

According to the invention the design of the gas connection of the fuel cell stack is such that the gas conduits of the fuel cell stack are arranged via only one surface, in this case via the first surface 2.1, whereby both the anode and cathode side gas conduits are on the same surface of the fuel cell stack. In the fuel cell arrangement the fuel cell stacks 2 are adapted to each other so that two fuel cell stacks are always in connection with a common inlet and collector piece 4.1, 4.2 via the gas conduits of the first surface 2.1. Thus the gas change of these two fuel cell stacks is accomplished through a common inlet and collector piece 4.1, 4.2. Thus the fuel cell pair is also facing each other between two inlet and collector pieces 4.1, 4.2.

The area of the inlet and collector piece is larger than that of the fuel cell stack, whereby it extends over the outer edge of the fuel cell stack. In the arrangement the tie bars are arranged to run longitudinally freely through the inlet and collector pieces, so the arrangement is floating in this aspect. The tie bars 6 are also essentially perpendicular in relation to the inlet and collector pieces. Preferably the holes for the tie bars in the inlet and collector pieces are provided with an insulation sleeve 8 acting as an electric insulator between the tie bar and the inlet and collector piece while simultaneously supporting the inlet and collector piece. By means of the insulator sleeve the inlet and collector piece can be electrically insulated from each other and can be thus kept in different potentials. Correspondingly, the end piece also comprises an insulation sleeve 5.1 at the fastening point of the tie bolts and thus also the end piece 5 can be kept in a potential different from that of the tie bars 6. When using the fuel cell arrangement provided according to the invention, the arrangement being a high-temperature arrangement, as arrangements based on solid oxide fuel cell are, there are considerable temperature changes taking place in different phases of the operation. However, the arrangement according to the invention allows good control of thermal expansion. While the long tie bars 6 and the tightening arrangement having springs provides sufficient compression power, the floating connection of the inlet and collector pieces, on the other hand, allows an even compression power in various connections while eliminating the forming of excessive tensions.

The design of the fastening plane element 3 is preferably such that both the anode side gas flow channels 3.1 and the cathode side gas flow channels 3.2 for each fuel cell tower are integrated therewith. The fastening plane element simultaneously acts as a structural bracket frame and it also separates two areas or spaces having distinctly different temperatures. Gas tubes are arranged from the gas flow channels 3.1, 3.2 of the fastening plane element to the first inlet and collector piece 4.1. The gas tubes also connect two consecutive inlet and collector pieces 4.1 and 4.2 with channel pieces located between them.

The first inlet tube 9.11 of the anode gas (fuel gas) is attached at its first end to the fastening plane at the place of the anode side flow channel 3.1 so that it is in flow connection with the flow channel 3.1. The first fuel gas inlet tube 9.11 is fastened at its one end to the first inlet and collector piece 4.1. The first inlet and collector piece 4.1 comprises a first channel 4.11 via which the anode gas is directed to two fuel cell stacks and further to the second inlet tube 10.11 of the fuel gas through which the anode gas is directed to the next fuel cell stack pair of the tower.

Correspondingly, the first inlet tube 9.21 of the cathode gas is also attached at its first end to the fastening plane at the place of the cathode side flow channel 3.2 so that it is in flow connection with the flow channel 3.2. The first cathode gas inlet tube 9.21 is fastened at its one end to the first inlet and collector piece 4.1. The first inlet and collector piece 4.1 comprises a second channel 4.12, through which the cathode gas is directed to two fuel cell stacks and further to the second cathode gas inlet tube 10.21. Each inlet tube is provided with a bellows or the like compensating the tensions otherwise caused by temperature changes.

In the fuel cell arrangement shown in FIG. 1 the two lowest fuel cell stacks 2 are adapted with each other so they face their common inlet and collector piece 4.1, through which the gas transfer of these two fuel cell stacks takes place. A number of fuel cell stacks can be arranged in pairs one on top the other, whereby the gas transfer of each fuel cell pair takes place through a dedicated inlet and collector piece.

The other end of the tower is provided with a second end piece 12 also compressing the stacks by means of tie bars 6. An electric insulation 13 is provided between the fastening plane and the second end piece for insulating the fuel cell tower from the fastening plane. Both the second end piece and the insulation 13 are provided with openings for inlet tubes 9.21, 9.11. Thus the inlet tubes do not extend to the fastening plane element 3.

FIG. 2 also illustrates the anode gas exhaust tubes 9.12 and cathode gas exhaust tubes 9.22 arranged in connection with the first inlet and collector piece 4.1. FIG. 2 also shows that the fastening plane element 3 is provided with gas flow channels for both the anode and cathode gas to be introduced to the fuel cell tower and the gas to be exhausted therefrom as required by each application. As has been noted, the inlet and exhaust of all gas flows of the fuel cell tower can preferably be arranged via the fastening plane element 3. Alternatively a part of the gas flows provided through the inlet and collector pieces can be arranged through separate tubes without a connection to the channels of the fastening plane element. In this case, e.g. inlet takes place through separate tubes and the exhaust flows are correspondingly directed via the fastening plane element, or, for example, the flows of the cathode side, inlet and exhaust, are provided through the fastening plane element.

The fuel cell stacks are electrically conductive and they are designed so that their terminals 15, 16 are in the opposite ends of the stack. The fuel cells are further arranged so that the terminals having the same potential are always in the same side as the inlet and collector piece of the fuel cell stack. Thus the fuel cell stacks 2 of the fuel cell tower are according to the invention so that the ends having the same potential are facing each other. This produces the advantage that the potential difference over the inlet and collector piece 4.1, 4.2 remains considerably small, whereby the electric insulation between the inlet and collector piece and the fuel cell stack does not, correspondingly, have to be very effectively insulating.

Correspondingly, the insulation 18 between the two fuel cell stacks does not have to be a very effective insulation, as these ends also have the terminal 16 for the same potential.

FIGS. 3 and 4 illustrate one practical embodiment of the design of the inlet and collector piece 4.1. The anode gas is introduced via channel 4.11 being in connection with the inlet tube 9.11 (not shown here, see FIG. 2), whereby the connection with the fuel cell stack is arranged via channels 4.111 and 4.112 so that it is carried out using the whole corresponding side surface of the fuel cell stack. The exhaust is accordingly carried out via channels 4.132 and 4.131 being in connection with the exhaust channel 4.13 and therethrough further to the exhaust tube 9.12 (not shown here, see FIG. 2). Cathode gas is correspondingly introduced via channel 4.12 being in connection with the inlet tube 9.21 (not shown here, see FIG. 2), whereby the connection with the fuel cell stack is arranged via channels 4.121 and 4.122 so that it is as well carried out using the whole corresponding side surface of the fuel cell stack. The exhaust is accordingly carried out via channels 4.142 and 4.141 being in connection with the exhaust channel 4.14 and therethrough further to the exhaust tube 9.22 (not shown here, see FIG. 2). The openings 4.15 are for passing the tie bars therethrough. All inlet and collector pieces of the fuel cell stack can be similar in design.

As can be seen in FIGS. 3 and 4, it is preferable for space usage to arrange some of the inlet and exhaust channels, here the anode side channels having a smaller diameter, in the central portion in the section plane of the fuel cell stack, not from the corners as shown in the principle drawing of FIG. 2. This has no effect on the stability of the tower, as the support of the fuel cell stacks is provided by means of tie bars 6 arranged symmetrically through openings 4.15. As can be seen, the tie bars 6 are in this embodiment closer to the actual fuel cell tower than the gas flow inlet and exhaust tubes.

FIG. 5 shows the principle of electrical connections between a number of fuel cell towers. According to the invention each fuel cell stack has its own ordinal number from the fastening plane element 3 so that closest to the fastening plane element is the first fuel cell stack 2, next is the second one and so on. The electric connection is carried out by connecting the fuel cell stacks 2 having the same number in series with each other with conductors 20. This is accomplished by connecting the terminals 15, 16; 15′, 16′ having different potentials to each other. As the ordinal number of the stack from the fastening plane also has an effect on its distance from the fastening plane, and in practice the towers preferably are vertical, the distance, i.e. height difference, causes a thermal difference between different distances as well. Because the temperature of a fuel cell has an effect on the operation of the fuel cell, the above-mentioned connection produces the advantage that the same electric serial connection has fuel cell stacks 2 operating in the same temperature, whereby their electricity production is as close to each other as possible.

The invention is not limited to the disclosed embodiments, but several modifications thereof can be conceived of within the appended claims.

1. A fuel cell arrangement comprising a number of fuel cell stacks formed by planar fuel cells, the fuel cells being arranged one after the other with each being provided with a gas connection for the inlet and exhaust flows of the gas of the anode and the cathode side, wherein the fuel cell stacks are arranged together positioned over a fastening plane element by means of an end piece and the fastening plane element and tie bars connecting them, that the gas connection comprises anode and cathode side conduits arranged on each of the first surfaces of the fuel cell stack and that the arrangement comprises at least two fuel cell stacks arranged one after the other, the anode and cathode side conduits of which are in connection with a common inlet and collector piece being between the said two fuel cell stacks arranged one after the other against the said first surfaces.

2. The fuel cell arrangement according to claim 1, wherein the fuel cell stacks are installed on both sides of the inlet and collector piece so that the ends of the fuel cell stacks with terminals having the same potential are facing the inlet and collector piece and each other.

3. The fuel cell arrangement according to claim 1, wherein the arrangement comprises two or more pairs of fuel cell stacks connected by means of an inlet and collector piece one after the other formed into a tower.

4. The fuel cell arrangement according to claim 3, wherein the inlet and collector pieces are connected to the common anode and cathode side gas tubes of the tower.

5. The fuel cell arrangement according to claim 4, wherein the gas tubes are provided with a bellows installed between each inlet and collector piece.

6. The fuel cell arrangement according to claim 4, wherein the gas tubes consist of channel pieces arranged between two consecutive inlet and collector pieces.

7. The fuel cell arrangement according to claim 3, wherein the holes for the tie bars in inlet and collector pieces are provided with an insulation acting as an electric insulation between the tie bar and the inlet and collector piece.

8. The fuel cell arrangement according to claim 3, wherein the arrangement comprises a number of towers formed by fuel cell stacks, the towers being fastened to the same fastening plane element comprising the gas flow channels for the anode and cathode side, the channels being in connection with the conduits of the fuel cell stacks of the anode and cathode side via the inlet and collector pieces.

9. The fuel cell arrangement according to claim 3, wherein the arrangement comprises a number of towers formed by fuel cell stacks and that the electric connection is carried out by connecting in series fuel cell stacks corresponding with each other in the order.
